(19) United States
(12) Patent Application Publication
(10) Pub. No.: US 2007/0007104 A1
(43) Pub. Date: Jan. 11, 2007

(54) Electronic coin recognition system

(76) Inventors: James S. Piccirillo, Middletown, CT (US); Justin Holmes, Old Saybrook, CT (US); Paul Stasieluk, Wallingford, CT (US); Jeffrey Thibeault, Branford, CT (US)

Correspondence Address: CANTOR COLBURN LLP, 55 Griffin Road South, Bloomfield, CT, 06002, US

(21) Appl. No.: 11/158,712

(22) Filed: Jun. 22, 2005

(51) Int. Cl. G07D 5/08

(52) U.S. Cl. 194/317

(57) ABSTRACT

A media recognition system includes a sensing part and a media discriminator. The sensing part is disposed proximate to a media to be queried and produces a sensing signal responsive to the media. The sensing signal is a digital signal produced in a single step by the sensing part from an analog signal. The media discriminator receives the sensing signal from the sensing part to determine acceptability of the media.

### BACKGROUND OF THE INVENTION

The present invention relates to a media recognition system and, more particularly, to a media recognition system having an improved detection system.

Media recognition systems have commonly been used to identify and/or differentiate between various media including, for example, coins, chips, tokens, etc. In the past, media recognition systems employed mechanical and simple electronic methods to accept or reject media and differentiate between denominations of media. The mechanical and simple electronic methods that have been employed often lead to improper acceptance of, for example, foreign coins, false media, unwanted media denominations, metal objects that look like proper media, etc. There is a recent trend toward improving operation of media recognition systems. However, improvements in media recognition system operation often require large and expensive detection systems.

### BRIEF DESCRIPTION OF THE INVENTION

Exemplary embodiments of the invention include a media recognition system. The media recognition system includes a sensing part and a media discriminator. The sensing part is disposed proximate to a media to be queried and produces a sensing signal responsive to the media. The sensing signal is a digital signal produced in a single step by the sensing part from an analog signal. The media discriminator receives the sensing signal from the sensing part to determine acceptability of the media.

Further exemplary embodiments of the invention include a media recognition system. The media recognition system includes a drop system, a sensing part and a media discriminator. The drop system inducing movement of media inserted into the media recognition system. The sensing part being disposed proximate to the drop system and producing a sensing signal responsive to the media. The sensing signal is a digital signal produced in a single step by the sensing part from an analog signal. The media discriminator receives the sensing signal from the sensing part to determine acceptability of the media

The above, and other objects, features and advantages of the present invention will become apparent from the following description read in conjunction with the accompanying drawings, in which like reference numerals designate the same elements.

### BRIEF DESCRIPTION OF THE DRAWINGS

Referring now to the drawings wherein like elements are numbered alike in the several FIGURES:

FIG. 1 is a block diagram of an electronic media recognition system according to an exemplary embodiment;

FIG. 2 is a block diagram of a media sensing portion and a media discriminator according to an exemplary embodiment; and

FIG. 3 shows an exemplary sensing path traced on a surface of a media.

### DETAILED DESCRIPTION OF THE INVENTION

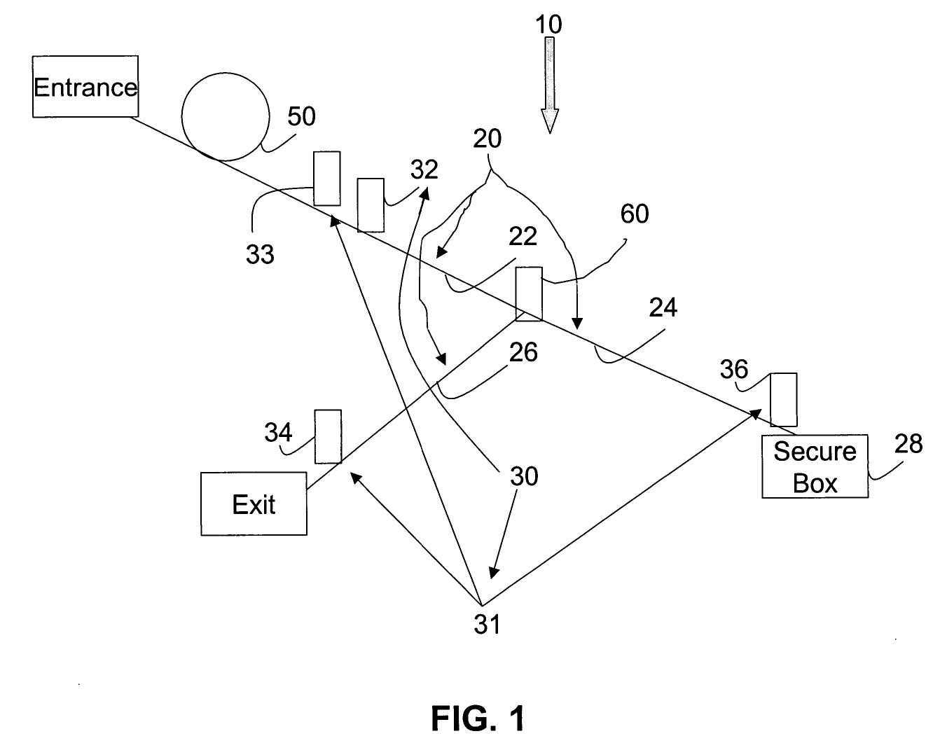

FIG. 1 shows a block diagram of an electronic media detection system according to an exemplary embodiment. The electronic media detection system (EMDS) 10 includes a drop system 20, an optional sensing part 30, and a media discriminator 40. Media 50 which includes, for example, coins, tokens, chips, etc., are inserted into the EMDS 10 via the drop system 20. The sensing part 30 includes a media location determination and calibration portion 31 and a media sensing portion 32. The media sensing portion 32 produces a sensing signal responsive to the media 50 and transmits the sensing signal to the media discriminator 40, which accepts or rejects the media 50 in response to the sensing signal.

Referring to FIG. 1, the drop system 20 includes a sensing path 22, a vault path 24, and a return path 26. The sensing, vault and return paths 22, 24 and 26 are each tilted at a selected angle such that the media 50 rolls on an edge portion of the media 50 while passing through the drop system 20. In an exemplary embodiment the sensing, vault and return paths 22, 24 and 26 are each tilted at a pitch of about 12 degrees and an angle of about 4 degrees over about 4 and ½ inches in order to slow a rolling speed of the media 50.

The sensing path 22 is disposed from an entrance of the EMDS 10 to a deflection gate 60. In an exemplary embodiment, the deflection gate 60 may be a solenoid. The deflection gate 60 includes an energized and a de-energized position. In response to the deflection gate 60 being in the de-energized position, the deflection gate 60 blocks access to the vault path 24 and media 50 that is rolling down the sensing path 22 is directed onto the return path 26. In response to the deflection gate 60 being in the energized position, the deflection gate 60 allows access to the vault path 24 and the media that is rolling down the sensing path 22 continues from the sensing path 22 onto the vault path 24.

The vault path 24 extends from the deflection gate 60 to a secure box 28. The secure box 28 provides a volume to receive media that have been accepted by the media discriminator 40. The secure box 28 may be accessed by an operator to remove stored media from the secure box 28.

The return path 26 extends from the deflection gate 60 to an exit of the EMDS 10. Since the deflection gate 60 directs media 50 down the return path 26 in response to the deflection gate 60 being in the de-energized position, the media 50 are returned to an individual who deposited the media 50 in the EMDS 10 in response to either the media 50 being determined to be unacceptable or the EMDS 10 lacking power.

The media location determination and calibration portion 31 of the sensing part 30 may include at least one location sensor disposed proximate to the drop system 20 so that the sensor produces a location signal responsive to media 50 moving past the sensor. In an exemplary embodiment, as shown in FIG. 1, the media location determination and calibration portion 31 includes a media optical entrance detector (MOED) 33, a media reject optical detector (MROD) 34, and a media acceptance optical detector (MAOD) 36. Although FIG. 1 shows three location sensors, it should be noted that either more or fewer location sensors may be employed. The MOED 33 is disposed at a selected position along the sensing path 22. In an exemplary embodiment, the MOED 33 includes a transmitting portion and a receiving portion. The transmitting portion transmits an optical beam to the receiving portion. The transmitting and receiving portions may be disposed on opposite sides of the sensing path 22, such that the media 50 breaks the optical beam from the transmitting portion to the receiving portion for a time period. Alternatively, the transmitting and receiving portions may be disposed on a same side of the sensing path 22, such that the media 50 reflects the optical beam from the transmitting portion to the receiving portion. The time period may be, for example, about 20 to about 30 milliseconds. Outputs transmitted from the MOED 33, the MROD 34 and the MAOD 36 are used for calibration of the EMDS 10 and media location determination within the EMDS 10.

The MROD 34 is substantially similar in structure to the MOED 33, thus a detailed explanation of the MROD 34 will be omitted. The MROD 34 is disposed at a selected portion of the return path 26, such that unacceptable media which has been directed onto the return path 26 breaks or reflects a beam of the MROD 34 to generate a reject verification signal. The reject verification signal verifies that the unacceptable media has been directed to the exit of the EMDS 10.

The MAOD 36 is substantially similar in structure to the MOED 33, thus a detailed explanation of the MAOD 36 will be omitted. The MAOD 36 is disposed at a selected portion of the vault path 24, such that acceptable media which has passed from the sensing path 22 to the vault path 24 breaks or reflects a beam of the MAOD 36 to generate an accept verification signal. The accept verification signal verifies that the acceptable media has been directed to the secure box 28. In an exemplary embodiment, a device employing the EMDS 10 provides a desired response only upon receipt of the accept verification signal.

It should be noted that although the MOED 33, the MROD 34 and the MAOD 36 described above are optical detectors, the present invention is not limited to such a configuration. Alternatively, the media location determination and calibration portion 31 may include any number of detectors operating via means other than an optical response to the media 50. Examples include, but are not limited to magnetic devices, mechanical switch devices, etc.

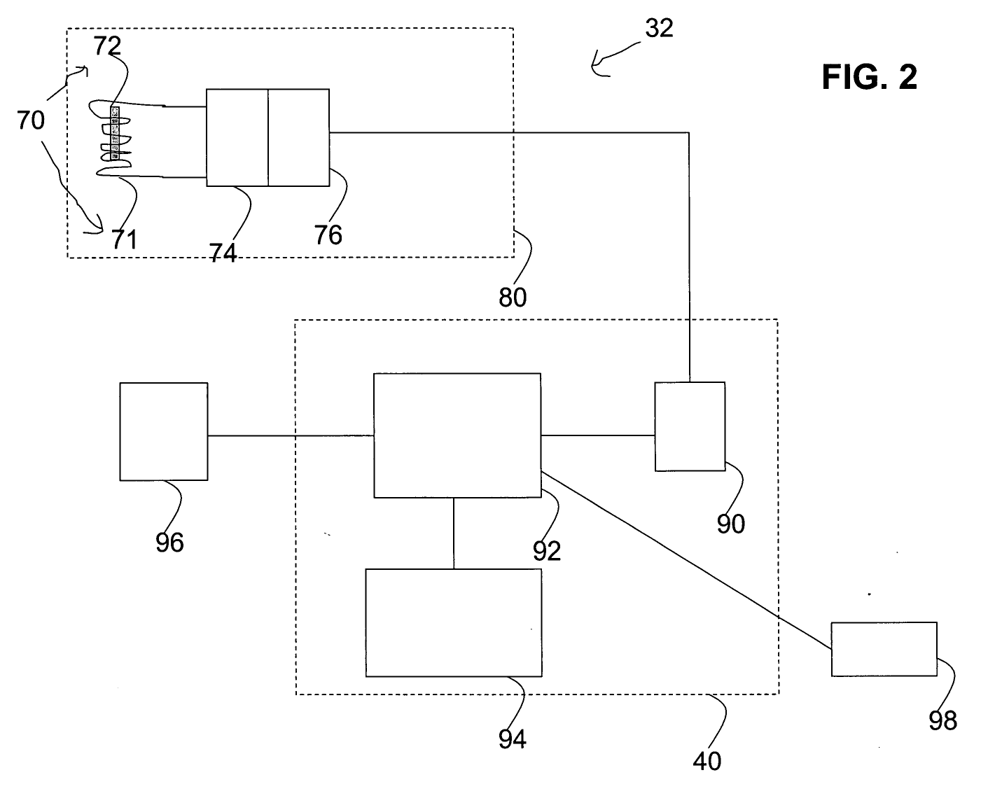

FIG. 2 is a block diagram of the media sensing portion 32 and the media discriminator 40 according to an exemplary embodiment. The media sensing portion 32 includes an air gapped eddy current detector 70, a current switch or comparator 74 and various resistors and capacitors 76 disposed to form a free running oscillator 80 operating in a range from about 25 kilohertz (KHz) to about 1 megahertz (MHz). In an exemplary embodiment, the free running oscillator 80 operates at a running frequency of about 60 KHz. The air gapped eddy current detector 70 includes a coil 71 (or inductor) disposed proximate to a ferrite core 72.

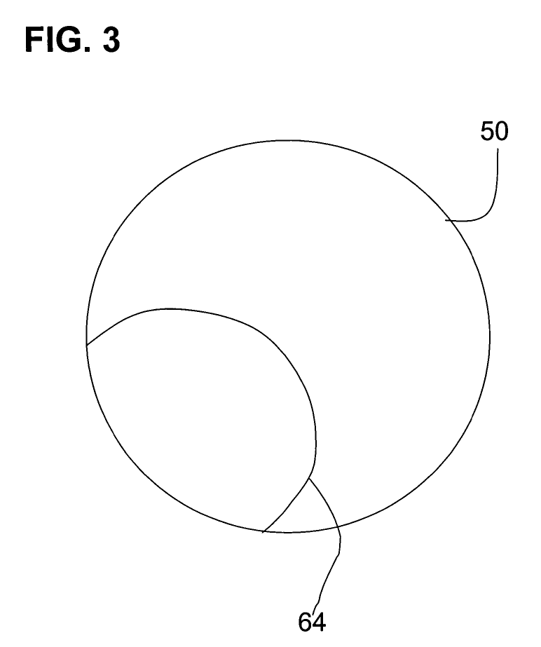

The air gapped eddy current detector 70 is disposed at a portion of the sensing path 22 such that the air gapped eddy current detector 70 is proximate to a surface of the media 50 as the media 50 moves down the sensing path 22. The air gapped eddy current detector 70 is an inductor. Thus, inductance of the air gapped eddy current detector 70 changes in response to a surface of the media 50. A topography of the media 50 comprises a series of raised and depressed portions to create an image on the surface of the media 50. Each of the series of raised and depressed portions produces a different inductance in the air gapped eddy current detector 70. For example, if the media 50 is a quarter, a rim of the quarter is about 0.008 inches above a lowest area on a surface of the quarter and a cheek of an image on a front side of the quarter is about 0.002 inches below the rim of the quarter and thus the inductance of the air gapped eddy current detector 70 is different in response to the air gapped eddy current detector 70 being proximate to either the rim of the quarter or the cheek of the image. An area of maximum sensitivity of the air gapped eddy current detector 70 may be small such as, for example, about 3 mm or less in diameter. As shown in FIG. 3, a sensed path 64 traced on the surface of the media 50 has a curved or spiral shape when media 50 rolls down the sensing path 22 or a straight line when media 50 slides down the sensing path 22.

An output frequency of the free running oscillator 80 changes responsive to changes in inductance of the air gapped eddy current detector 70 as the media 50 passes by the air gapped eddy current detector 70. In other words, the free running oscillator 80 outputs a distinct frequency in response to the area of maximum sensitivity of the air gapped eddy current detector 70 being proximate to distinct portions of the surface of the media 50. Thus, for example, a square wave comprising the 60 KHz running frequency is shifted in frequency, producing a frequency modulated digital signal in a single step. The frequency modulated digital signal, which comprises the sensing signal, is then output to the media discriminator 40.

As described above, an output frequency of the free running oscillator 80 is shifted from the running frequency due to changes in topography of the surface of the media 50. Frequency shifts due to the topography of the surface of the media 50 are called mapping shifts. However, the free running oscillator 80 also encounters frequency shifts responsive to a material comprising the media 50. For example, aluminum material causes a substantially different frequency shift than nickel material. Frequency shifts from the running frequency responsive to material are called material shifts. The free running oscillator 80 experiences both mapping and material shifts responsive to the media 50 and outputs the sensing signal which is the frequency modulated digital signal to the media discriminator 40.

The media sensing portion 32 may include a single free running oscillator 80 disposed at one side of the sensing path 22. Alternatively, the media sensing portion 32 may include a free running oscillator 80 disposed at opposite sides of the sensing path 22, such that both a front side and a back side of the media 50 are scanned by separate free running oscillators 80. As another alternative, a selected number of free running oscillators 80 may be disposed at either a same side or opposite sides of the sensing path 22 to improve certainty of identification of the media queried thereby.

The media discriminator 40 receives the sensing signal from the media sensing portion 32 and determines whether to accept or reject the media 50 responsive to the sensing signal. In response to the sensing signal indicating acceptable media, the media discriminator 40 energizes the deflection gate 60, thereby shifting the deflection gate 60 to the energized position and allowing the acceptable media to pass from the sensing path 22 to the vault path 24. In response to the sensing signal indicating unacceptable media, the media discriminator 40 does not energize the deflection gate 60, thereby either keeping the deflection gate 60 in the de-energized position or shifting the deflection gate 60 to the de-energized position to direct the unacceptable media from the sensing path 22 to the return path 26.

The media discriminator 40 includes a coin scan circuit (CSC) 90, a microprocessor 92, a memory 94, a power supply 96, and a status display 98. In an exemplary embodiment, the media discriminator 40 includes a field programmable gate array (FPGA) having circuitry programmed to perform as the CSC 90, the microprocessor 92 and the memory 94. An example of a suitable FPGA is produced by Altera. Alternatively, the media discriminator 40 may include an integrated circuit gate array (ICGA) or an application specific integrated circuit (ASIC). A hardware and software configuration of the EMDS 10 is automatically downloaded to the ICGA or FPGA after a power reset. Furthermore, the ICGA, ASIC or FPGA may include an electronic interface with drive capabilities sufficient to provide signals to the deflection gate 60 to shift the deflection gate 60 to either the energized position or the de-energized position.

The CSC 90 includes logic gates configured to convert the frequency modulated digital signal from the free running oscillator 80 into time varying binary values. The CSC 90 includes, for example, reset, edge detection, latch and counter circuits operating at about 250 MHz or more. CSC output from the CSC 90 is used by the microprocessor 92 for media determination, i.e. determination whether the media 50 is acceptable or unacceptable.

In an exemplary embodiment, the media location determination and calibration portion 31 includes a variable frequency oscillator (for example, as described above) which produces a base frequency responsive to the media 50. The base frequency of media 50 made of a particular metal is distinct. However, changes in temperature of the EMDS 10 may cause changes in a frequency sensed by the media sensing portion 32 and thus must be accounted for. Calculation of the base frequency by the media location determination and calibration portion 31 for each particular media 50 allows temperature deviations sensed by the media sensing portion 32 to be accounted for. Thus, for example, the media sensing portion 32 may acquire data that is slightly shifted due to temperature changes, however, the media location determination and calibration portion 31 senses a particular base frequency responsive to the temperature changes. A histogram for acceptable media at the particular base frequency of the media 50 will be used for comparison to account for the temperature changes.

The microprocessor 92 applies, for example, a calibration algorithm to calculate the base frequency and/or a media recognition algorithm to the CSC output to determine acceptability of the media 50. The media recognition algorithm may be one or both of a neural network algorithm (NNA) and a real time frequency algorithm (RTFA). The NNA processes the frequency modulated digital signal to determine the topography of the surface of the media 50. The topography of the surface of the media 50 is then compared to stored topography data for acceptable media that is stored in the memory 94. In other words, the NNA processes image shift data. The RTFA processes the frequency modulated digital signal to determine if the material of the media 50 is proper. In other words, the RTFA processes material shift data. The microprocessor 92 compares material shift data to a histogram and/or processes image shift data for acceptable media that is stored in the memory 94. Thus, the microprocessor 92 acts as a spectrum analyzer to distinguish between acceptable and unacceptable media in response to material shift data and/or image shift data. In an exemplary embodiment, the RFTA includes a fast Fourier transform (FFT). The FFT transforms real time data into a frequency domain. Data in the frequency domain may then by compared to acceptable histograms to determine whether or not the media is acceptable.

The memory 94 includes, for example, FLASH, serial PROM, SRAM, SDRAM, etc., which are all well known in the art. The FLASH and the serial PROM may contain the hardware and software configuration of the FPGA, ASIC or ICGA. The SRAM may contain temporary memory used by the microprocessor 92 as necessary. The SDRAM may contain the media recognition and calibration algorithms. The memory 94 includes the histograms for acceptable media.

The power supply 96 may be a conventional power supply unit. The power supply 96 may be a low voltage alternating current (AC) supply or a direct current (DC) wall unit. For example, a printed circuit board (PCB) mounted low voltage regulator may create appropriate DC levels for use by various circuits within the EMDS 10. The status display 98 indicates whether or not the media 50 was accepted or rejected responsive to the accept and reject verification signals, respectively. The status display 98 is powered from the power supply 96.

As stated above, the EMDS 10 may include the media sensing portion 32 that is capable of determining between acceptable and unacceptable media using the NNA and/or the RFTA. It is important to note that the EMDS 10 may include either or both of the NNA and the RFTA. Variations in frequency due to topography changes over the sensed path 64 traced on the surface of the media 50 may be, for example, about 5-10 KHz. Variations in frequency due to material changes of the media 50 may be, for example, larger than about 5-10 KHz. Additionally, variations in frequency due to material changes include changes in a thickness or density of a material. Thus, for example, a sensed frequency will differ from the running frequency by a certain amount for media 50 having the same material but different thicknesses or the same material but different density. A processing rate for the media sensing portion 32 is about 10 media per second.

In addition, while the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A media recognition system comprising:
a sensing part disposed proximate to a media to be queried and producing a sensing signal responsive to the media, the sensing signal being a digital signal produced in a single step by the sensing part from an analog signal; and
a media discriminator receiving the sensing signal from the sensing part to determine acceptability of the media.

2. The system of claim 1, wherein the sensing part comprises a location determining sensor.

3. The system of claim 1, wherein the sensing part comprises a free running oscillator that senses the media.

4. The system of claim 3, wherein the free running oscillator comprises:
a core;
a coil disposed proximate to the core; and
a comparator in electrical communication with the coil,
wherein an inductance of the free running oscillator varies in response to the media.

5. The system of claim 4, wherein an output of the free running oscillator is the digital signal produced in the single step by the sensing part.

6. The system of claim 1, wherein the media discriminator comprises:
a media scan circuit;
a microprocessor in electrical communication with the media scan circuit; and
a memory in electrical communication with the microprocessor.

7. The system of claim 6, wherein the media scan circuit converts the sensing signal to an output signal having a time varying binary value.

8. The system of claim 6, wherein the microprocessor discriminates between acceptable and unacceptable media responsive to at least one of:
material frequency shifts; and
image frequency shifts.

9. The system of claim 8, wherein a neural network algorithm is used to determine the image frequency shifts.

10. The system of claim 8, wherein a real time frequency algorithm is used to determine the material frequency shifts.

11. The system of claim 6, wherein the media discriminator includes one of a field programmable gate array and a digital processing circuit.

12. The system of claim 6, wherein the memory contains histograms for topographical features of acceptable media.

13. The system of claim 6, wherein the memory contains data corresponding to sensed paths traced on a surface of acceptable media.

14. A media recognition system comprising:
a drop system for inducing movement of media inserted into the media recognition system;
a sensing part disposed proximate to the drop system and producing a sensing signal responsive to the media, the sensing signal being a digital signal produced in a single step by the sensing part from an analog signal; and
a media discriminator receiving the sensing signal from the sensing part to determine acceptability of the media.

15. The system of claim 14, wherein the drop system comprises:
a first drop path disposed from an entrance of the media recognition system to a deflection gate;
a second drop path disposed from the deflection gate to a secure box; and
a third drop path disposed from the deflection gate to an exit of the media recognition system.

16. The system of claim 15, wherein the sensing part comprises:
a first sensor sensing a location of the media along the first drop path;
a second sensor sensing a location of the media along the second drop path; and
a third sensor sensing a location of the media along the third drop path.

17. The system of claim 15, wherein the deflection gate allows movement of the media from the first drop path to the second drop path in response to the deflection gate being energized and the deflection gate directs movement of the media from the first drop path to the third drop path in response to the deflection gate being de-energized.

18. The system of claim 17, further comprising a free running oscillator disposed proximate to the first drop path, the free running oscillator comprising:
a core;
a coil disposed proximate to the core; and
a comparator in electrical communication with the coil,
wherein an inductance of the free running oscillator varies in response to the media.

19. The system of claim 18, wherein the media discriminator comprises:
a media scan circuit;
a microprocessor in electrical communication with the media scan circuit; and
a memory in electrical communication with the microprocessor.

20. The system of claim 19, wherein the microprocessor discriminates between acceptable and unacceptable media responsive to at least one of:
material frequency shifts; and
image frequency shifts.
